(19) United States
(12) Patent Application Publication
(10) Pub. No.: US 2019/0113358 A1
(43) Pub. Date: Apr. 18, 2019

(54) DISPLAY PROCESSING DEVICE AND DISPLAY PROCESSING PROGRAM

(71) Applicant: PANASONIC INTELLECTUAL PROPERTY MANAGEMENT CO., LTD., Osaka (JP)

(72) Inventors: Takayoshi MORIYASU, Kanagawa (JP); Teruyuki KIMATA, Tokyo (JP)

(73) Assignee: PANASONIC INTELLECTUAL PROPERTY MANAGEMENT CO., LTD., Osaka (JP)

(21) Appl. No.: 16/088,655

(22) PCT Filed: Feb. 17, 2017
(86) PCT No.: PCT/JP2017/005868

§ 371 Date: Sep. 26, 2018

(30) Foreign Application Priority Data
Mar. 29, 2016 (JP) 2016-065415

(51) Int. Cl. G01C 21/36; G06F 3/041; G06F 3/0484; G06F 3/0488

(52) U.S. Cl. CPC G01C 21/367; G06F 3/041; G01C 21/3629; G06F 3/0488; G06F 3/0484

(57) ABSTRACT

A display processing device controls a screen displayed on a display unit. The display unit includes a pressure-sensitive sensor and a touch sensor. The display processing device includes: an input information acquisition unit that acquires input information including a position and pressing force of touch operation performed on the display unit; and a display controller that, when the touch operation having the pressing force greater than or equal to a threshold is performed while a first screen is displayed on the display unit, selects a second screen of a switching destination based on a position where the touch operation is performed, causes the second screen to appear from a side corresponding to a direction associated with the second screen, causes the first screen to move toward an opposite side of the side from which the second screen appears and disappear, and thereby switches the first screen with the second screen.

### TECHNICAL FIELD

The present invention relates to a display processing device and a display processing program.

### BACKGROUND ART

Typically, in an on-board navigation device, when a screen is switched from a navigation screen to other application screens, it requires an operation to select an icon of a function to be switched from a displayed list of menus after an operation to select a menu key or the like. For this reason, it is necessary for a user to perform at least a plurality of operations in order to switch the screen to another application screen, and it is also necessary to perform an operation to sequentially select the icons from the displayed screen.

From a viewpoint of such backgrounds, various user interfaces for switching the application screen are being studied. For example, PTL 1 discloses that an application display area displayed on a full screen and an application display area displayed on a sub-screen are provided in a display area. PTL 1 also discloses that a group of operation tabs for switching the applications is displayed.

### CITATION LIST

### Patent Literature

PTL 1: Unexamined Japanese Patent Publication No. 2010-134596

### SUMMARY OF THE INVENTION

An object of the present invention is to provide a display processing device and a display processing program for being able to realize a more suitable user interface in such a mode of use that the currently-displayed screen is switched to the desired screen.

According to one aspect of the present invention, a display processing device controls a screen displayed on a display unit. The display unit includes a pressure-sensitive sensor and a touch sensor. The display processing device includes an input information acquisition unit and a display controller. The input information acquisition unit acquires input information. The input information includes a position and pressing force of a touch operation performed on the display unit. The display controller, when the touch operation having the pressing force greater than or equal to a threshold is performed while a first screen is displayed on the display unit, selects at least one of a plurality of screens each of which is associated with one of four directions from a center of a display area of the display unit as a second screen with which the first image is to be switched, based on a position where the touch operation is performed when the touch operation is performed while a first screen is displayed on the display unit. The display controller causes the second screen to appear in the display area of the display unit from a side corresponding to a direction associated with the second screen. The display controller causes the first screen to move toward an opposite side of the side from which the second screen appears and disappear from the display area of the display unit. The display controller thereby switches the first screen with the second screen.

According to the display processing device of the present invention, the user can switch the display from the currently-displayed screen to the desired screen by reduced operations without moving a visual line too much.

### BRIEF DESCRIPTION OF DRAWINGS

FIG. 1 is a view illustrating an example of an appearance of a navigation device according to a first exemplary embodiment.

FIG. 2 is a view illustrating an example of a hardware configuration of the navigation device of the first exemplary embodiment.

FIG. 3 is a view illustrating an example of a functional block of a control device of the first exemplary embodiment.

FIG. 4 is an exploded perspective view illustrating a component configuration of a display unit of the first exemplary embodiment.

FIG. 5 is a sectional view illustrating the component configuration of the display unit of the first exemplary embodiment.

FIG. 6 is a flowchart illustrating an action of the navigation device of the first exemplary embodiment.

FIG. 7 is a view illustrating an example of a screen transition of a display screen in the navigation device of the first exemplary embodiment.

FIG. 8 is a view illustrating an example of a correspondence relationship between a screen switching operation and a switching destination screen of the first exemplary embodiment.

FIG. 9 is a view illustrating an example of a mode of an identification mark according to a second exemplary embodiment.

FIG. 10 is a view illustrating an example of a correspondence relationship between a screen switching operation and a switching destination screen according to a third exemplary embodiment.

FIG. 11 is a view illustrating setting data associating each of a plurality of screens according to a fourth exemplary embodiment with a positional relationship of each surface of a polyhedron.

### DESCRIPTION OF EMBODIMENTS

A problem in a conventional device will briefly be described prior to the description of exemplary embodiments of the present invention. In the conventional technique of PTL 1, the navigation screen can be switched to another application screen by one-time operation. However, in the conventional technique of PTL 1, although the display unit is used as the user interface, a tab used by the user to select the application is small, and it is necessary to select a desired tab from a plurality of tabs. For this reason, the conventional technique of PTL 1 has a problem in that it is difficult to quickly select the desired application.

In particular, for the on-board navigation device, the user performs an operation to switch an application screen in a short period of waiting time for a traffic signal to change during driving. For this reason, like the conventional technique of PTL 1, the user interface that focuses attention on the operation is unfavorable.

### First Exemplary Embodiment

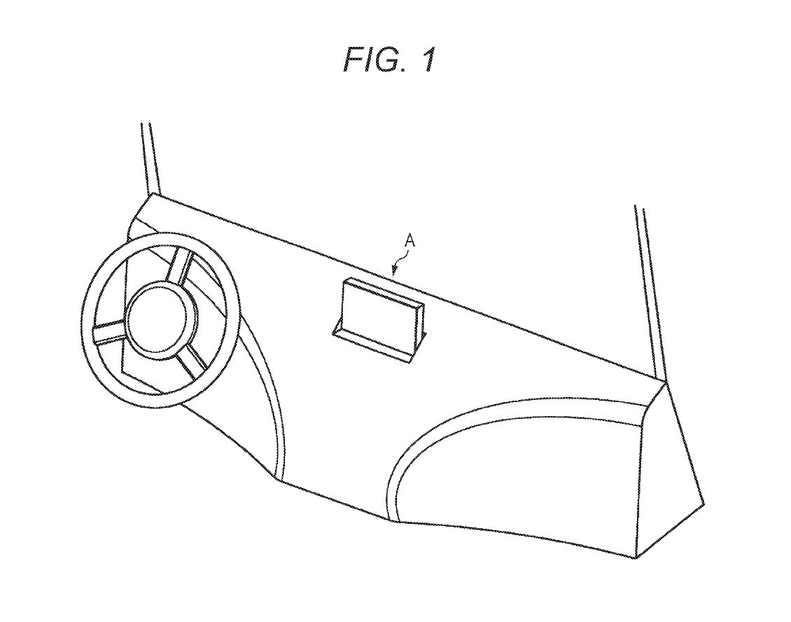

Hereinafter, an example of a configuration of a display processing device according to a first exemplary embodiment will be described with reference to FIGS. 1 to 5. The display processing device of the first exemplary embodiment is used in an on-board navigation device that displays a navigation screen of a map.

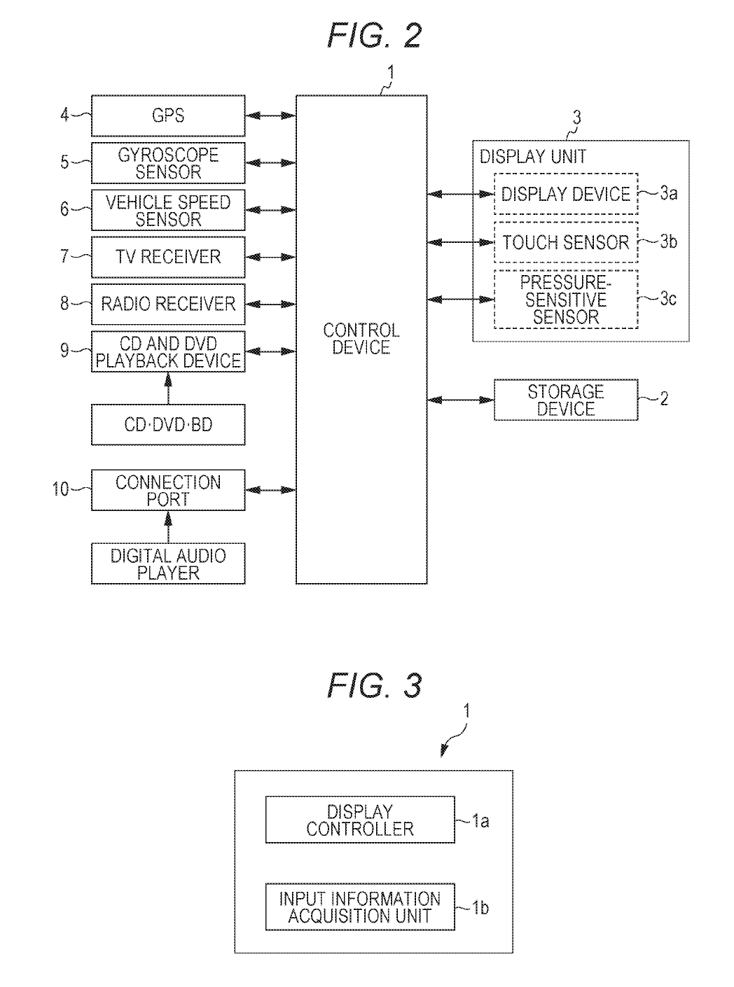

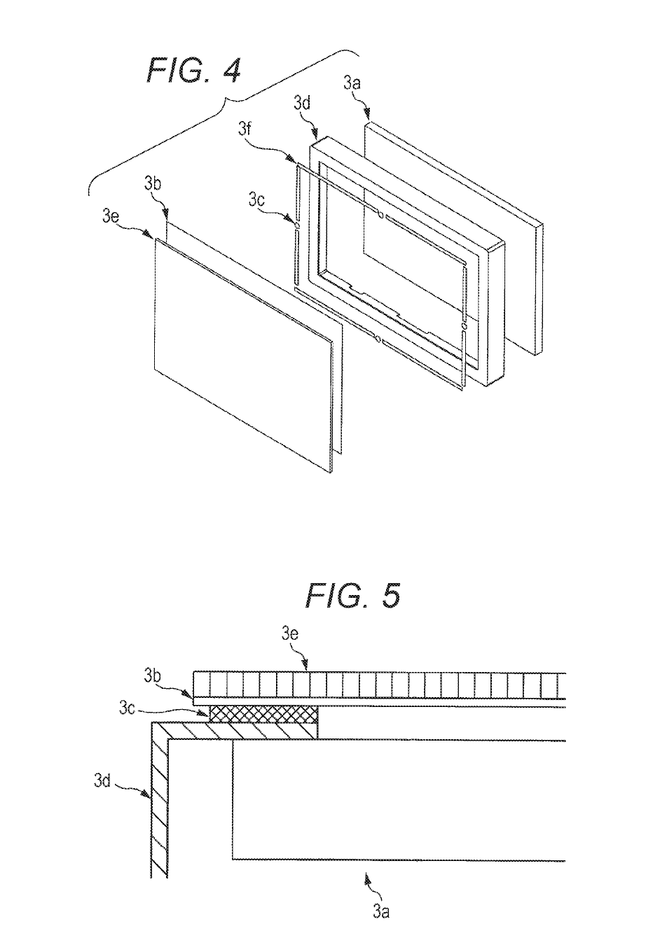

FIG. 1 is a view illustrating an example of an appearance of navigation device A according to the first exemplary embodiment. FIG. 2 is a view illustrating an example of a hardware configuration of navigation device A of the first exemplary embodiment. FIG. 3 is a view illustrating an example of a functional block of control device 1 of the first exemplary embodiment. FIG. 4 is an exploded perspective view illustrating a component configuration of display unit 3 of the first exemplary embodiment. FIG. 5 is a sectional view illustrating the component configuration of display unit 3 of the first exemplary embodiment.

Navigation device A includes control device 1, storage device 2, and display unit 3. Image data of, for example, the navigation screen is generated by these devices, or the navigation screen is displayed by these devices.

For example, control device 1 (display processing device) includes a central processing unit (CPU). The CPU executes a computer program, which allows control device 1 to perform data communication with the units of navigation device A to integratedly control actions of the units.

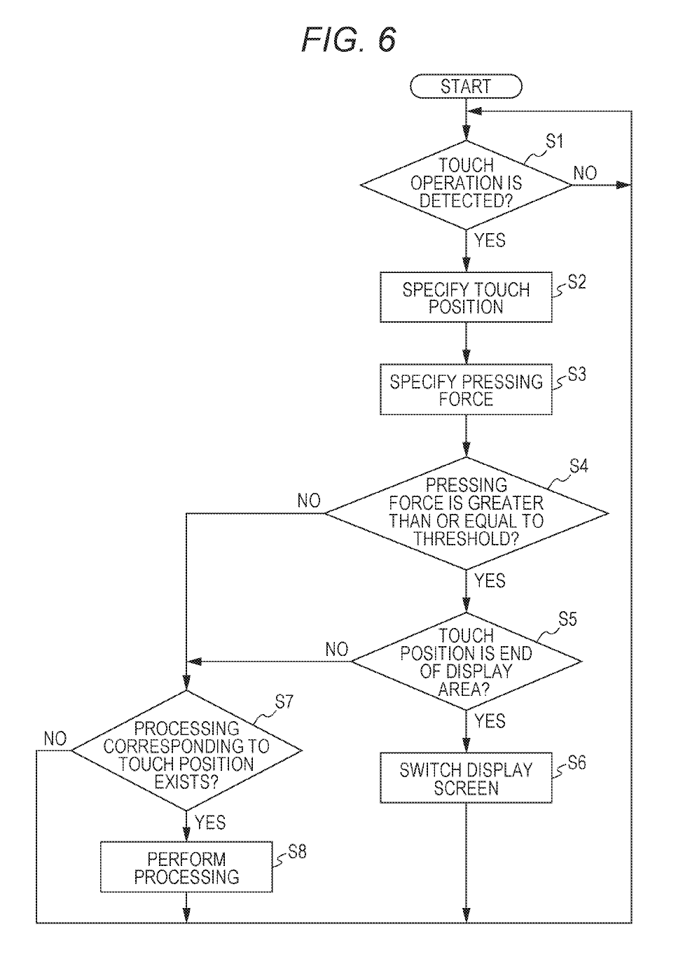

Control device 1 has functions of display controller 1a and input information acquisition unit 1b. For example, the CPU executes an application program to implement functions of display controller 1a and input information acquisition unit 1b (see FIG. 3: a detailed action in which the functions are used will be described later with reference to FIG. 6).

Display controller 1a generates image data of a screen displayed on display unit 3 (display device 3a) using image data stored in storage device 2, and controls a displayed image in response to a user's touch operation and the like. Display controller 1a performs the control based on input information including a position and pressing force of the touch operation, the position and the pressing force being acquired by input information acquisition unit 1b.

Input information acquisition unit 1b acquires the input information including the position and pressing force of the touch operation performed on display unit 3. For example, a signal indicating the position where the touch operation is performed is output from display unit 3 (touch sensor 3b) to a register included in control device 1. Input information acquisition unit 1b acquires the input information about the position where the touch operation is performed based on the signal stored in the register. For example, a signal indicating the pressing force at which the touch operation is performed is output from display unit 3 (pressure-sensitive sensor 3c) as a voltage value. Input information acquisition unit 1b acquires the input information about the pressing force in the touch operation based on the voltage value.

In the case that the application program is operated on a system program, input information acquisition unit 1b may acquire the pieces of input information about the position and pressing force of the touch operation from the system program. For example, according to a fact that the system program acquires the signals indicating the position and pressing force of the touch operation from touch sensor 3b and pressure-sensitive sensor 3c, input information acquisition unit 1b may acquire the corresponding data from the system program in an event-driven manner.

In this case, the pieces of input information about the position and pressing force of the touch operation are specified based on the signals output from touch sensor 3b and pressure-sensitive sensor 3c (to be described later). However, as a matter of course, another method may be adopted as long as the position and pressing force of the touch operation can be specified. For example, input information acquisition unit 1b may specify the position of the touch operation based on a balance of the pressing force acquired from a plurality of pressure-sensitive sensors 3c (FIG. 4) (to be described later).

In the functions of display controller 1a and input information acquisition unit 1b, a plurality of computers may work together using an application programming interface (API) or the like. Display controller 1a may have a configuration in which a part or whole of the processing performed on the image data is performed using a graphics processing unit (GPU) or the like.

Storage device 2 includes a read only memory (ROM), a random access memory (RAM), and a hard disk drive (HDD). Various processing programs such as the system program and the application program executable on the system program are non-transitorily stored in storage device 2, and various pieces of data are stored in storage device 2. Storage device 2 forms a work area where data is temporarily stored in calculation processing. Additionally, the image data or the like displayed on display unit 3 is stored in storage device 2. In storage device 2, the data or the like may rewritably be stored in an auxiliary storage device such as a flash memory in addition to the HDD. According to a position of a vehicle or a request by the touch operation, these pieces of data may successively be down-loaded through an Internet line, and stored in storage device 2.

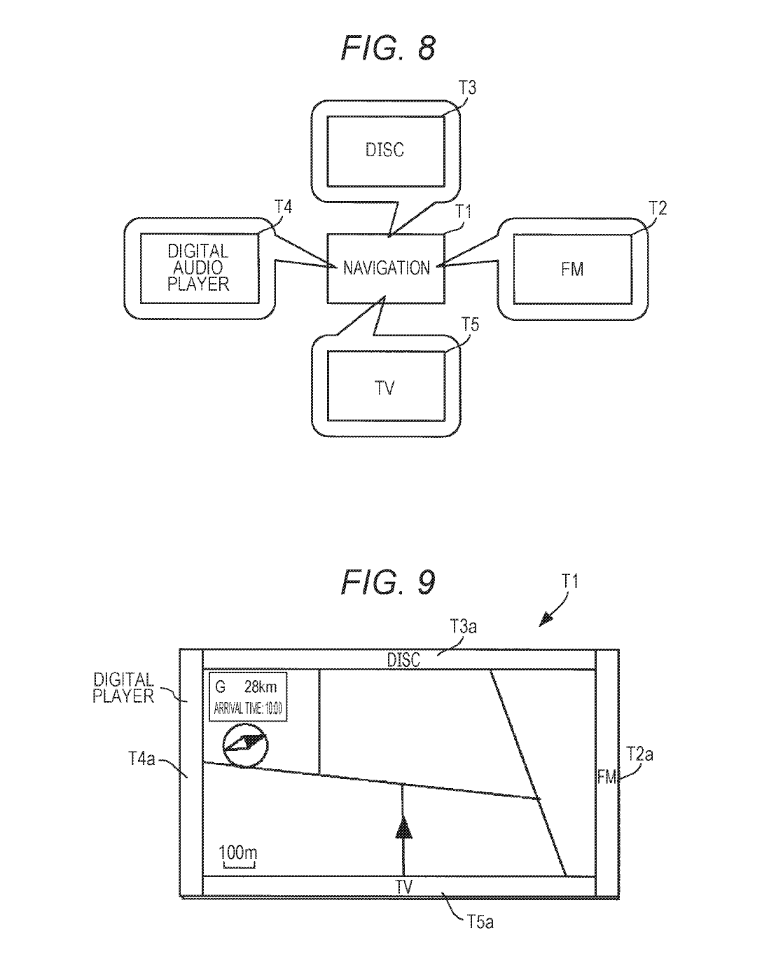

Storage device 2 includes a plurality of pieces of image data of display screen (to be described later with reference to FIG. 8) for operating the application. For example, storage device 2 includes pieces of image data such as a navigation screen for displaying a map image and a frequency modulation (FM) screen listening to an FM radio. Data relating to an icon and the like displayed in the screen is also attached to the pieces of image data, and a user can perform corresponding processing according to the position selected in the screen. Setting data (to be described later with reference to FIG. 8) indicating a correspondence relation between a screen switching operation and a switching destination screen and image data of the map image associated with a map coordinate displayed on the navigation screen are also stored in storage device 2.

Display unit 3 includes display device 3a, touch sensor 3b, and pressure-sensitive sensors 3c (see FIGS. 4 and 5).

For example, display device 3a is constructed with a liquid crystal display, and the navigation screen is displayed in a display area of the liquid crystal display. The image data for displaying the navigation screen and the like is input from control device 1 to display device 3a, and display device 3a displays the navigation screen and the like based on the image data.

Touch sensor 3b is an input device with which a user performs input to navigation device A. Touch sensor 3b detects the position where the touch operation is performed on the display area of display device 3a. For example, a projection type electrostatic capacitance touch sensor is used as touch sensor 3b, and a plurality of electrostatic capacitance sensors are formed in a matrix form on the display area of display device 3a by X-electrodes and Y-electrodes arrayed in a matrix form. Touch sensor 3b detects a change in electrostatic capacitance due to capacitive coupling generated between these electrodes and a finger when the finger comes close to touch sensor 3b using the electrostatic capacitance sensors, and detects the position where the touch operation is performed based on a detection result of the change in electrostatic capacitance. The detection signal is output to control device 1 as a signal indicating the position where the touch operation is performed. The position detected by touch sensor 3b may be subjected to correction processing so as to be matched with each position of the display area of display device 3a.

Pressure-sensitive sensor 3c is an input device with which the user performs the input to navigation device A. Pressure-sensitive sensor 3c detects the pressing force in the touch operation on the display area of display device 3a. For example, a sensor in which a resistance value changes according to contact pressure is used as pressure-sensitive sensor 3c, and pressure-sensitive sensor 3c detects the pressing force in the touch operation by converting a change of the resistance value into a voltage value. Four pressure-sensitive sensors 3c are respectively disposed at positions corresponding to four sides of an outer periphery of the display area of display device 3a. The signal indicating the pressing force in the touch operation detected by pressure-sensitive sensors 3c is output to control device 1.

Display unit 3 includes housing 3d, cover lens 3e, and double sided tape 3f in addition to display device 3a, touch sensor 3b, and pressure-sensitive sensors 3c described above.

Specifically, in display unit 3, display device 3a is accommodated in housing 3d such that the display area is exposed, and plate-shaped touch sensor 3b and cover lens 3e are disposed in this order so as to cover the display area of display device 3a. Plate-shaped touch sensor 3b is fixed to housing 3d using double sided tape 3f on an outside of an outer edge of the display area of display device 3a. Pressure-sensitive sensors 3c are disposed between plate-shaped touch sensor 3b and housing 3d on the outer periphery of the display area of display device 3a. When performing the touch operation on display unit 3, the user performs the touch operation on a surface of cover lens 3e.

Navigation device A also includes global positioning system (GPS) terminal 4, gyroscope sensor 5, vehicle speed sensor 6, television (TV) receiver 7, radio receiver 8, compact disc and digital versatile disc (CD and DVD) playback device 9, and connection port 10 to which a digital audio player is connected. Control device 1 can also perform data communication with these devices. These devices are publicly-known, so that the detailed description will be omitted.

### <Action of Navigation Device A>

An example of an action of navigation device A of the first exemplary embodiment will be described below with reference to FIGS. 6 to 8.

FIG. 6 is a flowchart illustrating the action of navigation device A of the first exemplary embodiment. The action flowchart is the action performed by control device 1. For example, control device 1 performs the processing according to the application program, thereby performing the action flowchart. In particular, screen switching processing performed by display controller 1a will be described below. As used herein, the “screen” means an image that is displayed so as to occupy a major part of the display area of display unit 3. Display controller 1a performs control such that one of the plurality of screens is displayed in the display area of display unit 3. A temporal change of the display in switching the currently-displayed screen to another screen is also referred to as “screen transition”. The touch operation performed by the user in order to switch the currently-displayed screen to another screen is also referred to as a “screen switching operation”, and the switching destination screen in switching the currently-displayed screen (first screen) to another screen is abbreviated to a “switching destination screen” (second screen).

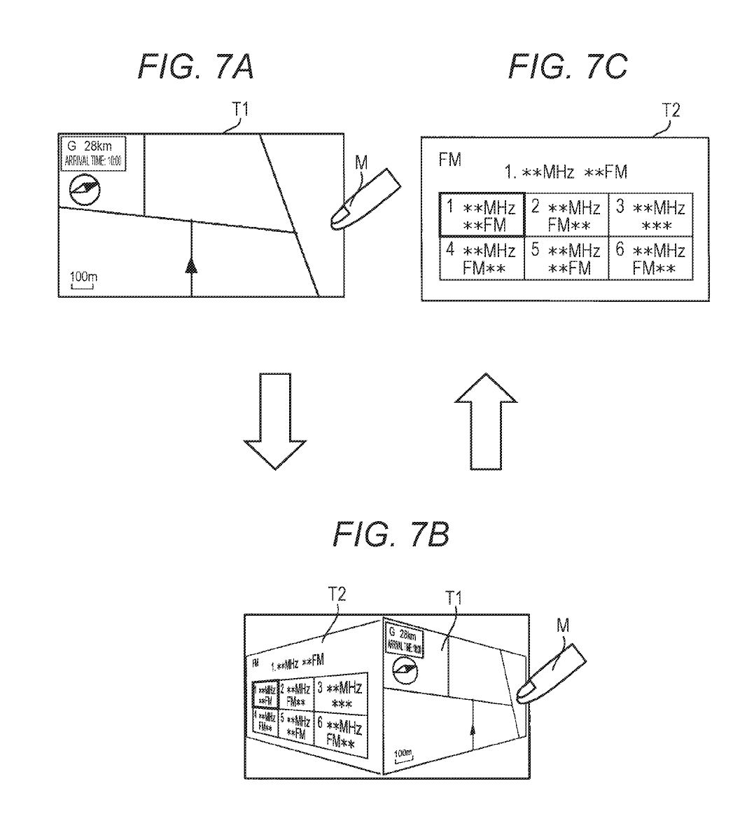

FIG. 7 is a view illustrating an example of a screen transition of a display screen in navigation device A. For example, the display screen in parts (A) to (C) of FIG. 7 is generated by display controller 1a based on the image data of the screen set in each application, and sequentially updated according to the action of display controller 1a in FIG. 6.

The part (A) of FIG. 7 illustrates navigation screen T1 (first screen), the part (C) of FIG. 7 illustrates screen T2 (second screen) for listening to the FM radio, and the part (B) of FIG. 7 illustrates an example of the screen transition from navigation screen T1 to screen T2 for listening to the FM radio. An outer frame of the image in FIG. 7 expresses an outer frame of the display area of display unit 3, and the reference mark M in FIG. 7 denotes the touch operation to the display area.

FIG. 8 is a view illustrating an example of setting of the switching destination screen in the case that screen switching operation is performed. In FIG. 8, in the case that the touch operation to press a right end of the display area of display unit 3 is performed while navigation screen T1 is displayed, the switching to FM screen T2 is set in order to listen to the FM radio using radio receiver 8. Similarly, in the case that the touch operation to press an upper end of the display area of display unit 3 is performed, the switching to DISC screen T3 is set in order to listen to the CD using CD and DVD playback device 9. In the case that the touch operation to press a left end of the display area of display unit 3 is performed, the switching to audio screen T4 is set in order to operate the digital audio player. In the case that the touch operation to press a lower end of the display area of display unit 3 is performed, the switching to TV screen T5 is set in order to watch TV using TV receiver 7.

That is, screens T2 to T5 are associated with four directions from a center of the display area of display unit 3, respectively. The correspondence relationship between the screen switching operation and the switching destination screen is previously stored as setting data, and read by the application program.

When the application program is executed in the action flowchart in FIG. 6, display controller 1a initially displays the navigation screen (part (A) of FIG. 7). At this time, display controller 1a reads positional data of the vehicle acquired by GPS terminal 4, generates the map image from the map coordinate corresponding to the positional data of the vehicle such that the position of the vehicle is located near the center of the display screen, and displays the navigation screen.

Display controller 1a then waits for the user to perform touch operation M on display unit 3 (NO in step S1). For example, the touch operation of the user is determined by monitoring the signal from touch sensor 3b, the signal being input from input information acquisition unit 1b to control device 1.

When touch operation M is performed on display unit 3 (YES in step S1), input information acquisition unit 1b first specifies the touch position of touch operation M in the display area of display unit 3 based on the signal from touch sensor 3b (step S2). Input information acquisition unit 1b acquires the signal from pressure-sensitive sensor 3c to specify the pressing force of touch operation M (step S3).

Display controller 1a determines whether the pressing force acquired by input information acquisition unit 1b is greater than or equal to a threshold (step S4). When the pressing force is determined to be less than the threshold (NO in step S4), display controller 1a performs subsequent steps S7, S8 as the normal touch operation. On the other hand, when the pressing force is determined to be greater than or equal to the threshold (YES in step S4), display controller 1a performs subsequent steps S5, S6 as not the normal touch operation.

When the pressing force of touch operation M is determined to be less than the threshold (NO in step S4), display controller 1a determines whether the processing corresponding to the touch position of touch operation M exists in order to perform the processing as the normal touch operation (step S7). When the processing exists (YES in step S7), the processing (for example, processing of moving the map image) is performed (step S8), and display controller 1a returns to the waiting state in step S1 again. When the processing corresponding to the touch position of touch operation M does not exist (NO in step S7), display controller 1a returns to the waiting state in step S1 without performing any processing.

On the other hand, in step S4, when the pressing force of touch operation M is determined to be greater than or equal to the threshold (YES in step S4), display controller 1a determines whether the touch position is a screen edge in order to check the screen switching operation (step S5). As used herein, the screen edge means, for example, the outer edge of the display area of display unit 3. Whether the touch position is the screen edge is determined based on the touch position specified in step S2.

When the touch position is determined to be not the screen edge (NO in step S5), display controller 1a performs identification as not the screen switching operation, and performs step S7. On the other hand, when the touch position is determined to be the screen edge (YES in step S5), display controller 1a performs subsequent step S6.

Display controller 1a performs the display screen switching processing (step S6). At this point, display controller 1a selects the switching destination display screen based on the setting data in FIG. 8. For example, in the case that the user performs touch operation M on the right end of the display area of display unit 3, display controller 1a selects screen T2 for listening to the FM radio as the switching destination screen. Display controller 1a switches the display from navigation screen T1 in part (A) of FIG. 7 to FM screen T2 in part (C) of FIG. 7 by performing the display control illustrated in part (B) of FIG. 7. Display controller 1a returns to the waiting state in step S1 again. Display controller 1a performs the display control of display unit 3 by repeating the above action.

The screen transition in step S6 performed by display controller 1a will be described below.

As described above, part (B) of FIG. 7 illustrates a mode, in which the screen transitions to FM screen T2 associated with the right end side (a right direction with respect to the center of the display area) of the display area of display unit 3 on which touch operation M is performed, as an example of the screen transition

At this point, display controller 1a moves the image of navigation screen T1 toward the right side that is the touch position of the display area of display unit 3, and causes the image of navigation screen T1 to disappear outside the display area of display unit 3. Display controller 1a then performs the display control, in which the image of navigation screen T1 is moved and the image of FM screen T2 appears from the left side of the display area of display unit 3, so as to follow the movement of the image of navigation screen T1. That is, display controller 1a causes the selected screen to appear in the display area of display unit 3 from the side corresponding to the direction associated with the screen. At the same time, display controller 1a causes the currently-displayed screen to disappear from the display area of display unit 3 toward the opposite side to the side on which the selected screen is caused to appear.

The wording “the side corresponding to the direction associated with the screen” means the side of screen on which the position (the direction with respect to the center of the display area) where the screen switching operation is performed is identified, and the side corresponding to the direction associated with the screen is not necessarily identical to the direction with respect to the center of the display area where the screen switching operation is performed. For example, the side corresponding to the direction associated with the screen may be the side on which the screen is caused to appear from the opposite side to the side on which the screen switching operation is performed as illustrated in part (B) of FIG. 7. The screen may not appear or disappear from the end of the display area of display unit 3. The term “appear” means that the state in which the switching destination screen is not displayed in the display area of display unit 3 becomes the state in which the switching destination screen is displayed in the display area of display unit 3. Similarly, the term “disappear” means that the currently-displayed screen becomes the state in which the currently-displayed screen is not displayed in the display area of display unit 3.

More particularly, display controller 1a moves and causes to disappear the image of navigation screen T1 toward the right side of the display area of display unit 3 such that a hexahedron including navigation screen T1 and FM screen T2 in its adjacent surfaces rotates toward the side pushed into by touch operation M. At the same time, the image of FM screen T2 is moved and caused to appear from the left side of the display area of display unit 3.

The image of navigation screen T1 and the image of FM screen T2 are temporally deformed and moved while disposed adjacent to each other, which allows the display control in imitation of the rotation of the polyhedron to be well performed. For example, a stereoscopic effect like the rotation of the polyhedron can be expressed by enhancing image density in the area of the screen toward a depth direction using an affine transformation.

For example, display controller 1a increases compression rates of navigation screen T1 in an up-and-down direction and a right-and-left direction toward the right direction, which allows display controller 1a to perform three-dimensional display in which navigation screen T1 is inclined toward the depth direction at the right end of the display area of display unit 3. Display controller 1a moves navigation screen T1 to the right end side of the display area of display unit 3 while temporally increasing the compression rates of navigation screen T1 in the up-and-down direction and the right-and-left direction. Consequently, the display can be performed such that one surface of the hexahedron facing straight ahead moves gradually to a side surface. Display controller 1a performs similar processing on the image of FM screen T2.

In this way, display controller 1a can perform the three-dimensional display, in which the hexahedron is rotated to the right side to cause navigation screen T1 disposed in one surface to disappear temporally and to cause FM screen T2 disposed in adjacent surface to appear temporally.

In navigation device A of the first exemplary embodiment, the user can switch to the desired screen by touch operation M to push into the end in one of the four directions in the display area of display unit 3. Consequently, the user is aware of only one of the four directions in the display area of display unit 3, so that the user can switch simply to the desired screen by the one-time touch operation without moving the visual line too much. Thus, navigation device A of the first exemplary embodiment can construct the user interface suitable for such a use mode that the desired screen is selected from the plurality of screens to switch the screen to the desired screen.

Additionally, in switching currently-displayed screen T1 to screen T2 selected by the user, navigation device A of the first exemplary embodiment causes selected screen T2 to appear in the display area of display unit 3 from the side corresponding to the associated direction so as to rotate the polyhedron. At the same time, navigation device A performs the display control such that currently-displayed screen T1 is caused to disappear on the opposite side to the side on which selected screen T2 appears. Consequently, the user can switch the display screen with a feeling as if the polyhedron is rotated by pressing touch operation M. For this reason, the user can intuitively identify and instinctively store the correspondence relationship between the screen switching operation and the switching destination screen. The screen switching operation becomes an intuitive operation for the user, so that the screen switching operation contributes to the improvement of an interest.

According to navigation device A of the first exemplary embodiment, in switching the currently-displayed screen to the desired screen, display controller 1a determines whether touch operation M is performed on the end of the display area of display unit 3 in addition to the determination whether the pressing force of touch operation M is greater than or equal to the threshold. With this configuration, the user can be prevented from switching to the unintentional screen by an unintentional excessively pressing operation.

However, in the case that the pressing force of touch operation M is greater than or equal to the threshold, display controller 1a may switch the screen without determining whether touch operation M is performed on the end of the display area. In this case, display controller 1a may determine which one of the up-and-down and right-and-left directions is the position where touch operation M is performed with respect to the center of the display area of display unit 3, and switch to the screen associated with the corresponding direction.

In the first exemplary embodiment, the mode (FIG. 8) in which the display screen is switched to FM screen T2 and the like by the screen switching operation while navigation screen T1 is displayed is described as an example of the correspondence relationship between the screen switching operation and the switching destination screen. However, any type of the screen can be selected.

### Second Exemplary Embodiment

Navigation device A according to a second exemplary embodiment will be described below with reference to FIG. 9. Navigation device A of the second exemplary embodiment differs from navigation device A of the first exemplary embodiment in that the correspondence relationship between the screen switching operation and the switching destination screen is displayed as an identification mark. The description of other components common to those of the first exemplary embodiment will be omitted (hereinafter, the same holds true for other exemplary embodiments).

FIG. 9 is a view illustrating an example of a mode of the identification mark indicating the correspondence relationship between the screen switching operation and the switching destination screen. In FIG. 9, the position of the screen switching operation is expressed by display positions of identification marks T2a to T5a, and the type of the switching destination screen is expressed by text images of identification marks T2a to T5a.

Any method for indicating the correspondence relationship can be adopted, and various changes can be made by an image mode, an image color, and the like.

Identification marks T2a to T5a are displayed by the display control of display controller 1a. For example, display controller 1a reads setting data indicating the correspondence relationship between the screen switching operation and the switching destination screen every time the display screen is switched, and decides the modes and display positions of identification marks T2a to T5a based on the setting data. Display controller 1a displays identification marks T2a to T5a while superposing those identification marks T2a to T5a on the currently-displayed screen.

As described above, according to navigation device A of the second exemplary embodiment, the user can comprehend the correspondence relationship between the screen switching operation and the switching destination screen by the identification mark displayed on the currently-displayed screen. Consequently, the user can be prevented from switching wrongly to a different screen.

### Third Exemplary Embodiment

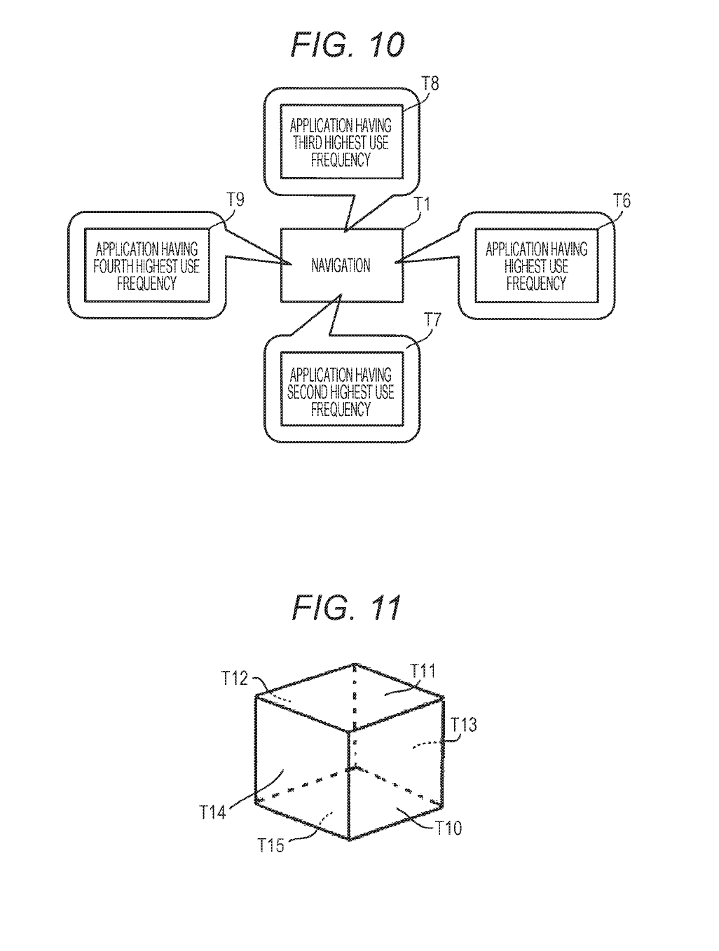

Navigation device A according to a third exemplary embodiment will be described below with reference to FIG. 10. Navigation device A of the third exemplary embodiment differs from navigation device A of the first exemplary embodiment in that navigation device A of the third exemplary embodiment includes a setting unit that changes the setting of the correspondence relationship between the screen switching operation and the switching destination screen based on a use frequency.

FIG. 10 is a view corresponding to FIG. 8, and is a view illustrating another example of the correspondence relationship between the screen switching operation and the switching destination screen.

In FIG. 10, the switching to screen T6 of the application having the highest use frequency is set in the case that the touch operation to press the right end of the display area of display unit 3 is performed while navigation screen T1 is displayed. Similarly the switching to screen T7 of the application having the second highest use frequency is set in the case that the touch operation to press the lower end of the display area of display unit 3 is performed. The switching to screen T8 of the application having the third highest use frequency is set in the case that the touch operation to press the upper end of the display area of display unit 3 is performed. The switching to screen T9 of the application having the fourth highest use frequency is set in the case that the touch operation to press the left end of the display area of display unit 3 is performed.

The navigation device is typically installed near the center in the front portion of the vehicle interior. Consequently in the case that the vehicle is right-hand drive, the right end side of the display area of display unit 3 is closest to the driver's seat, and becomes the disposition having the best operability for the driver. Thus, the right end side of the display area of display unit 3 is desirably associated with screen T6 of the application having the highest use frequency.

By this request, the setting unit of the third exemplary embodiment changes the screens corresponding to the four directions with respect to the center of the display area of display unit 3 based on the use frequencies of the application screens T6 to T9. For example, the use frequency referred to by the setting unit is a number of times of the switching to the screen that is stored in storage device 2 while associated with the application screen, and is comprehended by incrementing the number of times every time display controller 1a switches the application screen. The use frequency is not limited to the number of times of the switching to the application screen. For example, a total of time during which the application screen is displayed in a given period can also be used as the use frequency.

For example, the program executes the processing in predetermined timing, thereby constructing the setting unit. For example, when navigation device A is powered on to start the application program, the setting unit is performed to update the setting data indicating the correspondence relationship between the screen switching operation and the switching destination screen based on the use frequency.

As described above, according to navigation device A of the third exemplary embodiment, the correspondence relationship between the screen switching operation and the switching destination screen is updated based on the use frequency, so that the user can more easily perform the screen switching operation when the application screen has the higher use frequency.

### Fourth Exemplary Embodiment

Navigation device A according to a fourth exemplary embodiment will be described below with reference to FIG. 11. Navigation device A of the fourth exemplary embodiment differs from navigation device A of the first exemplary embodiment in that navigation device A of the third exemplary embodiment includes a second setting unit that changes the setting of the correspondence relationship between the screen switching operation and the switching destination screen while associating the correspondence relationship with a positional relationship among the surfaces of the polyhedron.

FIG. 11 is a view illustrating the positional relationship among the surfaces of the reference polyhedron when the second setting unit changes the setting of the correspondence relationship between the screen switching operation and the switching destination screen. FIG. 11 illustrates the state in which six application screens T10 to T15 are disposed as the surfaces of the hexahedron, respectively. FIG. 11 is a view illustrating the setting data associating the plurality of screens with the surfaces of the polyhedron, and it is unnecessary to hold the image data of the polyhedron, as a matter of course.

The second setting unit sets the correspondence relationship between the screen switching operation and the switching destination screen such that the positional relationship among the surfaces of the polyhedron is obtained as illustrated in FIG. 11 with the currently-disposed screen as a reference. For example, in the case that screen T10 is displayed, the second setting unit sets screen T11 as the switching destination screen in the screen switching operation performed on the upper end of the display area of display unit 3.

Screen T13 is set as the switching destination screen in the screen switching operation performed on the right end of the display area of display unit 3.

Screen T15 is set as the switching destination screen in the screen switching operation performed on the lower end of the display area of display unit 3.

Screen T14 is set as the switching destination screen in the screen switching operation performed on the left end of the display area of display unit 3.

For example, the second setting unit performs the setting processing every time display controller 1a switches the display screen. For example, in the case that the display screen is switched to screen T11, the second setting unit changes the switching destination screens associated with the up-and-down and right-and-left directions to screen T12, screen T10, screen T14, and screen T13, respectively.

Consequently, display controller 1a can switch the screen such that the screen is associated with positional relationship among the surfaces of the hexahedron. For this reason, the user can further decrease a number of operation times of the screen switching operation when switching the currently-displayed screen to another screen.

For example, in FIG. 8, when switching FM screen T2 to DISC screen T3, the user needs such the two-time screen switching operation that the switching to DISC screen T3 is performed after the switching to navigation screen T1 is performed once. In contrast, in the screen switching operation of the fourth exemplary embodiment, each of application screens T10 to T15 includes the plurality of switching destination screens. Thus, for example, in the case that FM screen T2 and DISC screen T3 are set to the adjacent surfaces of the polyhedron, the user can perform the screen switching operation from switch FM screen T2 to DISC screen T3 at one time.

Additionally similarly to the first exemplary embodiment, in switching to the screen selected by the user, the user of display controller 1a of the fourth exemplary embodiment rotates the polyhedron such that the correspondence relationship between the screen switching operation and the switching destination screen can instinctively be stored. Consequently, the user can instinctively store the correspondence relationship even if the positional relationship of the hexahedron in setting the correspondence relationship between the screen switching operation and the switching destination screen.

As described above, according to navigation device A of the fourth exemplary embodiment, the number of operation times of the screen switching operation can be decreased, and the user can instinctively store the correspondence relationship between the screen switching operation and the switching destination screen. The screen switching operation becomes the intuitive operation for the user, so that the screen switching operation contributes to the improvement of the interest.

### Fifth Exemplary Embodiment

Navigation device A according to a fifth exemplary embodiment differs from navigation device A of the first exemplary embodiment in that display controller 1a changes a screen transition speed according to the pressing force during the screen switching operation.

The display control can be performed by previously setting the screen transition speed according to the pressing force of touch operation M. As used herein, the screen transition speed means a speed in which the image is deformed since the starting of the screen transition until the ending of the screen transition in switching the currently-displayed screen to the selected screen as illustrated in FIG. 7.

The action of navigation device A of the fifth exemplary embodiment will be described according to the action flowchart in FIG. 6. In step S4, display controller 1a first identifies a pressing force level corresponding to a plurality of set thresholds in determining the pressing force of touch operation M. Display controller 1a decides the speed of the associated screen transition based on the pressing force level. In step S6, display controller 1a changes the display screen based on the screen transition speed decided in this way.

As described above, according to navigation device A of the fifth exemplary embodiment, the user can change the screen transition speed by the pressing force, so that the operation more intuitive for the user is obtained to contribute to the improvement of the interest. The user can increase and decrease the screen transition speed as necessary, so that user-friendliness is improved.

Although specific examples of the present invention are described above in detail, they are mere exemplifications and do not limit the scope of claims. The technique described in the claims includes various variations and changes of the specific examples exemplified above.

At least the following matter will be apparent from the description of the specification and the accompanying drawings.

Display processing device 1 of the present disclosure controls the screen displayed on display unit 3. Display unit 3 includes pressure-sensitive sensor 3c and touch sensor 3b. Display processing device 1 includes input information acquisition unit 1b and display controller 1a. Input information acquisition unit 1b acquires input information. The input information includes the position and pressing force of touch operation M performed on display unit 3. When touch operation M having the pressing force greater than or equal to the threshold is performed while first screen T1 is displayed on display unit 3, display controller 1a selects at least one of the plurality of screens each of which is associated with one of the four directions from the center of the display area of display unit 3 as second screen T2 with which the first screen T1 is to be switched, based on the position where touch operation M is performed. Second screen T2 is caused to appear in the display area of display unit 3 from the side corresponding to the direction associated with second screen T2, first screen T1 is caused to move toward an opposite side of the side from which second screen T2 appears and disappear from the display area of display unit 3, and thereby first screen T1 is switched with second screen T2. In display processing device 1, the user can switch to the desired screen by touch operation M to push into the end in one of the four directions in the display area of display unit 3. Consequently, the user is aware of only one end of the four directions in the display area of display unit 3, so that the user can switch simply to the desired screen by one-time touch operation M without moving the visual line too much.

For touch operation M having the pressing force greater than or equal to the threshold, display controller 1a may perform the processing of switching the display from first screen T1 to second screen T2 when the position where touch operation M is performed is the outer edge of the display area of display unit 3. In display processing device 1, the user can be prevented from switching to the unintentional screen by the unintentional excessively pressing operation.

While the image of first screen T1 and the image of second screen T2 are disposed adjacent to each other in switching the display from first screen T1 to second screen T2, the image of each screen is temporally deformed and moved to rotate the polyhedron in which first screen T1 and second screen T2 are disposed as the adjacent surfaces, whereby display controller 1a may cause second screen T2 to appear in the display area of display unit 3 from the side corresponding to the associated direction, and cause first screen T1 to disappear from the display area of display unit 3 toward the opposite side to the side on which second screen T2 is caused to appear. In display processing device 1, the user can intuitively identify and instinctively store the correspondence relationship between the screen switching operation and the switching destination screen. The screen switching operation becomes an intuitive operation for the user, so that the screen switching operation contributes to the improvement of an interest.

Display processing device 1 may include the setting unit that changes the screen associated with at least one of the four directions with respect to the center of the display area of display unit 3 based on stored use frequency data of each of the plurality of screens. In display processing device 1, the user can more easily perform the screen switching operation when the application screen has the higher use frequency.

Display processing device 1 may include the second setting unit that changes the screen associated with at least one of the four directions with respect to the center of the display area of display unit 3 such that the screen is associated with the positional relationship among the surfaces of the polyhedron associated with the switched screen every time first screen T1 is switched based on the setting data associating each of the plurality of screens with the positional relationship among the surfaces of the polyhedron. In display processing device 1, the number of operation times of the screen switching operation can further be decreased.

Display controller 1a may distinguishably display the correspondence relationship between the direction and the type of screen with respect to each of the plurality of screens associated with at least one of the four directions with respect to the center of the display area of display unit 3. In display processing device 1, the user can comprehend the correspondence relationship between the screen switching operation and the switching destination screen, and be prevented from wrongly switching to the different screen.

When switching the display from first screen T1 to second screen T2, display controller 1a may change the speed at which first screen T1 is caused to disappear and the speed at which second screen T2 is caused to appear according to the pressing force of touch operation M. In display processing device 1, the user can change the screen transition speed by the pressing force, so that the operation more intuitive for the user is obtained to contribute to the improvement of the interest.

The display processing program of the present disclosure controls the screen displayed on display unit 3. Display unit 3 includes pressure-sensitive sensor 3c and touch sensor 3b. The display processing program includes the processing of acquiring the input information and the processing of switching the display. In the processing of acquiring the input information, the input information is acquired. The input information includes the position and pressing force of touch operation M performed on display unit 3. In the processing of switching the display, when touch operation M having the pressing force greater than or equal to the threshold is performed while first screen T1 is displayed on display unit 3, at least one of the plurality of screens associated with the four directions from the center of the display area of display unit 3 is selected as second screen T2 with which the first screen T1 is to be switched, based on the position where touch operation M is performed. Second screen T2 is caused to appear in the display area of display unit 3 from the side corresponding to the direction associated with second screen T2, first screen T1 is caused to move toward an opposite side of the side from which second screen T2 appears and disappear from the display area of display unit 3, and first screen T1 is switched with second screen T2.

### INDUSTRIAL APPLICABILITY

A display processing device of the present disclosure can suitably be used in a navigation device.

### REFERENCE MARKS IN THE DRAWINGS

A: navigation device
1: control device (display processing device)
1a: display controller
1b: input information acquisition unit
2: storage device
3: display unit
3a: display device
3b: touch sensor
3c: pressure-sensitive sensor
3d: housing
3e: cover lens
3f double sided tape
4: GPS terminal
5: gyroscope sensor
6: vehicle speed sensor
7: TV receiver
8: radio receiver
9: CD and DVD playback device
10: connection port

1. A display processing device that controls a screen displayed on a display unit, the display unit including a pressure-sensitive sensor and a touch sensor, the display processing device comprising:
an input information acquisition unit that acquires input information, the input information including a position and pressing force of a touch operation performed on the display unit; and
a display controller that, when the touch operation having the pressing force greater than or equal to a threshold is performed while a first screen is displayed on the display unit, selects at least one of a plurality of screens each of which is associated with one of four directions from a center of a display area of the display unit as a second screen with which the first screen is to be switched, based on a position where the touch operation is performed, causes the second screen to appear in the display area of the display unit from a side corresponding to a direction associated with the second screen, causes the first screen to move toward an opposite side of the side from which the second screen appears and disappear from the display area of the display unit, and thereby switches the first screen with the second screen.

2. The display processing device according to claim 1, wherein for the touch operation having the pressing force greater than or equal to the threshold, the display controller performs processing of switching the display from the first screen to the second screen when the position where the touch operation is performed is an outer edge of the display area of the display unit.

3. The display processing device according to claim 1, wherein when switching the display from the first screen to the second screen, the display controller rotates a polyhedron in which the first screen and the second screen are disposed as adjacent surfaces, causes the second screen to appear in the display area of the display unit from the side corresponding to the direction associated with the second screen, and causes the first screen to move toward the opposite side of the side from which the second screen appears and disappear from the display area of the display unit.

4. The display processing device according to claim 1, further comprising a setting unit that changes the screen associated with at least one of the four directions from the center of the display area of the display unit based on stored use frequency data of each of the plurality of screens.

5. The display processing device according to claim 3, further comprising a second setting unit that changes the screen associated with at least one of the four directions from the center of the display area of the display unit such that the screen is associated with a positional relationship among the surfaces of the polyhedron associated with the switched screen every time the first screen is switched based on setting data associating the plurality of screens with the positional relationship among the surfaces of the polyhedron.

6. The display processing device according to claim 1, wherein the display controller distinguishably displays a correspondence relationship between the direction and a type of the screen with respect to each of the plurality of screens associated with at least one of the four directions from the center of the display area of the display unit.

7. The display processing device according to claim 1, wherein when switching the display from the first screen to the second screen, the display controller changes a speed at which the first screen is caused to disappear and a speed at which the second screen is caused to appear according to the pressing force of the touch operation.

8. A display processing program that controls a screen displayed on a display unit including a pressure-sensitive sensor and a touch sensor, the display processing program causing a computer to perform:
processing of acquiring input information including a position and pressing force of a touch operation performed on the display unit; and
processing of, when the touch operation having the pressing force greater than or equal to a threshold is performed while a first screen is displayed on the display unit, selecting at least one of a plurality of screens each of which is associated with one of four directions from a center of a display area of the display unit as a second screen with which the first screen is to be switched, based on a position where the touch operation is performed, causing the second screen to appear in the display area of the display unit from a side corresponding to a direction associated with the second screen, causing the first screen to move toward an opposite side of the side from which the second screen appears and disappear from the display area of the display unit, and thereby switching the first screen with the second screen.
